(19) United States
(12) Patent Application Publication
(10) Pub. No.: US 2004/0189493 A1
(43) Pub. Date: Sep. 30, 2004

(54) RF electronic license plate and information system for vehicle tracking

(76) Inventors: Jay M. Estus, Darby, MI (US); Leonard O. Wallace, Post Falls, ID (US); Phillip Ganza, Matteson, IL (US)

Correspondence Address: Donald W. Meeker, 924 East Ocean Front #E, Newport Beach, CA, 92661, US

(21) Appl. No.: 10/401,002

(22) Filed: Mar. 27, 2003

(51) Int. Cl. G08G 1/123

(52) U.S. Cl. 340/988; 340/539.13

(57) ABSTRACT

A motor vehicle tracking and information system that uses a radio-frequency electronic vehicle license plate in conjunction with roadside receivers and an information system architecture. The system is used to identify and track vehicles, detecting vehicles operating in violation of the law, and automatically issuing citations.

### BACKGROUND OF THE INVENTION

1. Field of the Invention

The present invention relates to a motor vehicle tracking and information system. Using radio frequency electronic vehicle license plates in conjunction with roadside receivers and an information system, vehicles can be tracked to determine current location, and violations of law can be detected and automatically cited without law enforcement resources.

2. Description of the Prior Art

With heightened awareness of the importance of homeland security and ever-increasing demands on public safety resources, maintaining peace and safety has become increasingly difficult and costly. History proves that the actions of a single terrorist can instill fear the lives of millions of people, disrupting and paralyzing society while doing great economic harm. These events are often used to justify more police, followed by legislation reducing civil liberties. As an alternative to more police, this invention is an information system designed to enhance the efficiency of law enforcement, improve the efficiency of companies involved in transportation, and improve highway safety.

Electronic license plates have been the subject of prior inventions. For example, electronic license plates for conveying visual information are described in U.S. Pat. No. 5,105,179 to J. Wise Smith. The device is an electronic replacement for the existing metal plate but does not transmit or receive electromagnetic information to support vehicle tracking.

U.S. Pat. No 4,001,822 to Sterzer describes a vehicle communication system in which a unitary electronic license plate having a plurality of layers responds to an impinging interrogation or probing signal of a given frequency and transmits this coded information back to receiver electronics in the interrogation device. The Sterzer patent also provides the ability within the electronic license plate to detect coded information from the transmitter or interrogation device. A fundamental difference between the Sterzer patent and the present invention is that whereas the Sterzer device requires an interrogation signal to activate the license plate, the present invention is an active, asynchronously transmitting device which randomly transmits the coded ID signal at intervals ranging between one-half and four seconds. There is no interrogating device used in the present invention. There is only a receiver, and the active license plate which randomly broadcasts vehicle identity. This present invention is unique in that the asynchronous transmission provides inherent RF collision avoidance. By using an actively transmitting plate, which randomly transmits its ID codes, multiple vehicles within range of the receiver can be read. Furthermore, whereas the Sterzer electronic license plate is capable of receiving coded information through the interrogation signal, making it a bi-directional communication system, the present invention is unidirectional only, electromagnetically transmitting coded digital information, and also visually conveying compliance information as defined in detail in following sections.

U.S. Pat. No. 5,608,391 issued to Bantli et al describes a two-piece electronic license plate architecture whereby the identification components are located in the license plate, and signal processing and communication electronics are located in a separate module, preferably a license plate holder. In this present invention all electronics are incorporated into a unitary plate. Also, unique to the present invention is the active, asynchronous transmission which mitigates RF collisions resulting from multiple transponders within range of the receiver.

Additional security enhancements to Bantli U.S. Pat. No. 5,608,391 are described in U.S. Pat. No. 5,657,008 to Bantli. Whereas the Bantli plate as described in U.S. Pat. No. 5,657,008 is rendered inoperable when the identification device is removed from the license plate holder, in the present invention the plate continues to operate when placed on another vehicle, thereby providing continual information on vehicle location. However, the code structure is changed indicating to the Central Information System (CIS) that the plate is no longer on the proper vehicle.

U.S. Pat. No. 6,025,784 issued to Mish describes various methods of forming license plate frames and integrating RFID transponders into these assemblies. As with the Bantli patent described above, the subject invention is a unitary license plate having all electronics integrated into the plate. It does not rely upon electronics incorporated into a frame or other mounting device. Also unique to the present invention is the use of illumination for conveying status and security information. Finally, whereas the Mish patent describes the use of RFID in the traditional sense in which an RFID chip in the license plate frame receives an interrogation signal and then responds, the subject invention is an active RF transmitter which broadcasts vehicle information randomly to a receiver. There is no interrogation signal used in the subject invention.

Yet another patent to Talmadge, et al, U.S. Pat. No. 20020101332 describes an RF license plate, which, like the Sterzer and Mish inventions described above, requires the use of an interrogation device to energize or activate the license plate to respond by transmitting its radio frequency modulated signal. Again, the unique and novel approach of the present invention requires no interrogation signal from a roadside transceiver. Receivers, therefore, are greatly simplified. Also, wherein prior art addresses merely transmitter and receiver components of identification or tracking systems, the present invention encompasses a complete information system which includes asynchronously-transmitter RF license plates, receivers, and an information architecture for integrating information from various agencies and users.

### SUMMARY OF THE INVENTION

The general object of the subject invention is to provide an integrated system for tracking motor vehicles. To attain this objective the present invention essentially comprises a tamper-proof, electronic vehicular license plate having all electronic components integrated therein, roadside and mobile receivers for detecting vehicles and decoding the RF transmission, and an information system for making the data useful to law enforcement, industry, and private citizens. There are, of course, additional features of the invention that will be described hereinafter and which will form the subject matter of the claims appended hereto.

Another primary object of the present invention is to improve highway safety. Speed kills, and used as a device for detecting speeding vehicles this tracking system will encourage motorists to slow down. By placing receivers several miles apart a vehicle's average velocity can accurately be determined, providing a more accurate assessment of driving habits than instantaneous velocity as determined by radar-equipped highway patrol. Speeding tickets can be processed automatically, reducing the demand for dedicated highway patrol officers, while saving taxpayers money.

Another object of the present invention is to improve safety at railroad crossings. Railroad crossings continue to be a source of danger for both trains and motor vehicles. Despite warning lights and automatic gates, impatient drivers continue to cross tracks if they think that there is enough time to safely get away with it. Through behavior modification this vehicle tracking system provides an inexpensive, yet effective solution to this problem. A receiver is placed at each railroad crossing and all vehicles crossing the tracks after the warning signals are activated or gates have been lowered, are read. A couple days later the vehicle owner receives a citation in the mail for a moving vehicle violation.

Another object of the present invention is to reduce taxpayer costs associated with vehicle licensing and highway safety. Many states redesign and reissue new plates every five years or so to aid in identifying plates that are being used without current registration. While the cost of an RF electronic license plate will be higher than that of a conventional metal plate, the plate will not require replacement every few years and therefore the cost savings will more than offset the capital cost of buying the plate. Furthermore, the present invention will improve compliance with vehicle registration, insurance and emission requirements, vehicle inspections, commercial vehicle permits, and payment of citations. By integrating data from multiple agencies, vehicles operating in noncompliance can be identified and citations can be automatically generated; all without the need for police, thereby reducing taxpayer costs through improved efficiency.

Still another object of the present invention is to provide a tool for supporting crime scene investigations. Recognizing that virtually all crimes involve, or are supported by vehicular transportation, this tracking and information system will provide a tool for focusing investigative efforts at crime scenes. For example, by correlating the time at which a crime is committed to a database of vehicles driving in that particular area, police can significantly speed up the investigation. Also, if police are searching for a specific vehicle this identification and tracking system will report where the vehicle was last read.

Yet another object of the present invention is to improve the efficiency of the transportation industry. Scheduling and locating commercial freight shipments, or determining where delinquent rental cars are located are just a couple examples. Self-serve gas stations could install readers to identify cars being fueled, thereby eliminating losses from drive-off customers. The public may also use the information system for determining the whereabouts of the family car. An Internet pay-per-play system can enable various users to access location information while generating income to offset operating costs.

An ensuing object of present invention is to improve toll-booth efficiency. While “One-Pass” and other RFID systems currently demonstrate the technology, a vast majority of drivers continue to pay by cash resulting in delays for everyone. This vehicle identification system would provide a universal platform for automatic toll invoicing.

Another object of the present invention is to facilitate traffic studies for community planning. Using this tracking system the specific demographics of vehicular traffic can be evaluated to more accurately assess traffic patterns.

Finally, an object of the present invention is to provide a tool for analyzing traffic patterns across country borders for the purpose of identifying vehicles associated with smuggling, drug trafficking or other illegal activities.

Also unique to the present invention is the use of status illumination. This visual status illumination flashes when the plate is removed from the original vehicle, indicating to law enforcement that the vehicle is operating in noncompliance. Furthermore, the present invention incorporates the ability to externally program status illumination electronics, as will be described in further detail.

In brief, the subject invention consists of a tamper-proof, electronic vehicular license plate having all electronic components integrated therein, roadside or mobile receivers for detecting vehicles and decoding the transmission, and an information architecture for making the data useful to law enforcement, industry, and private citizens.

The license plate is of unitary construction. Electronics embedded into the license plate include an antenna, a transmitter, multiple one-time programmable (OTP) memory circuits, an erasable programmable read-only memory (EPROM), a CPU and clock circuit, illumination electronics, security electronics and a power supply and conditioning. All electronics are mounted to a dielectric substrate and encapsulated, or encased between front and rear composite panels which are permanently joined together either by means of welding or chemical bond.

Whereas retro-reflective letters and numbers are standard on license plates to visually convey the identity of the vehicle, the present invention also incorporates electronic illumination to convey operational status and other information.

The OTP circuits provide unique plate identity. One OTP chip is programmed with the license plate number at the time of manufacture. A second OTP chip is reserved for the vehicle ID number and is programmed by the Department of Motor Vehicles when the plate is issued. The EPROM is used by law enforcement for programming status illumination.

The electronic plate is mounted to the vehicle in the typical manner. There is an umbilical between the plate and the vehicle, which supplies the plate with power, and security logic as will be described.

The receiver uplinks stored records periodically to the Central Information System (CIS) by means of a communication link. The CIS is a data bank containing insurance records, DMV records, emissions records, vehicle inspection records, commercial vehicle permit records, and law enforcement records. While law enforcement has dial-up access to these records, others have access only to specific records through an Internet browser. FIG. 4 illustrates the Information Architecture.

Advantages of the present invention include;

1. Improved highway safety;

2. Improved compliance at railroad crossings resulting in fewer accidents;

3. Improved compliance with insurance, registration, and licensing requirements;

4. Enhanced public safety through improved efficiency of crime investigation;

5. Fewer travel delays due to a universal platform for toll-booth automation;

6. Efficiency improvements for private industry through improved information of vehicle identity and location.

### BRIEF DESCRIPTION OF THE DRAWINGS

These and other details of this invention will be described in connection with the accompanying drawings, which are furnished only by way of illustration and not in limitation of the invention, and in which drawings:

FIG. 1 is a front elevation view of the license plate construction;

FIG. 2 is a side cross-sectional view of the license plate construction;

FIG. 3 is a functional block diagram of the electronic plate as it interfaces to the vehicle, and the receiver;

FIG. 4 is a high-level flow chart of the information architecture.

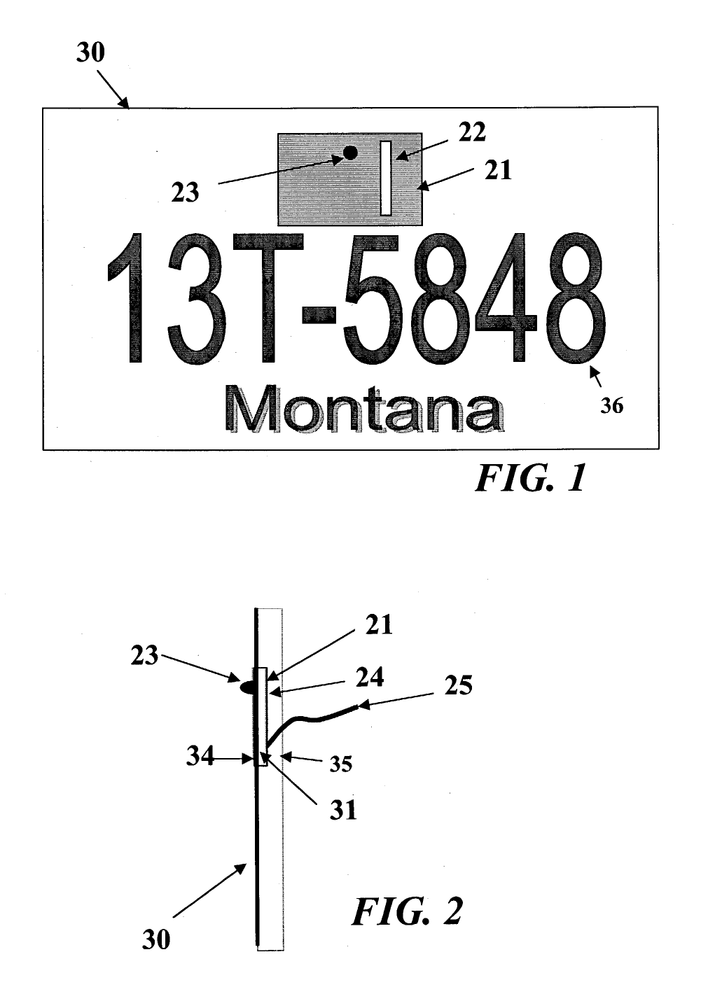

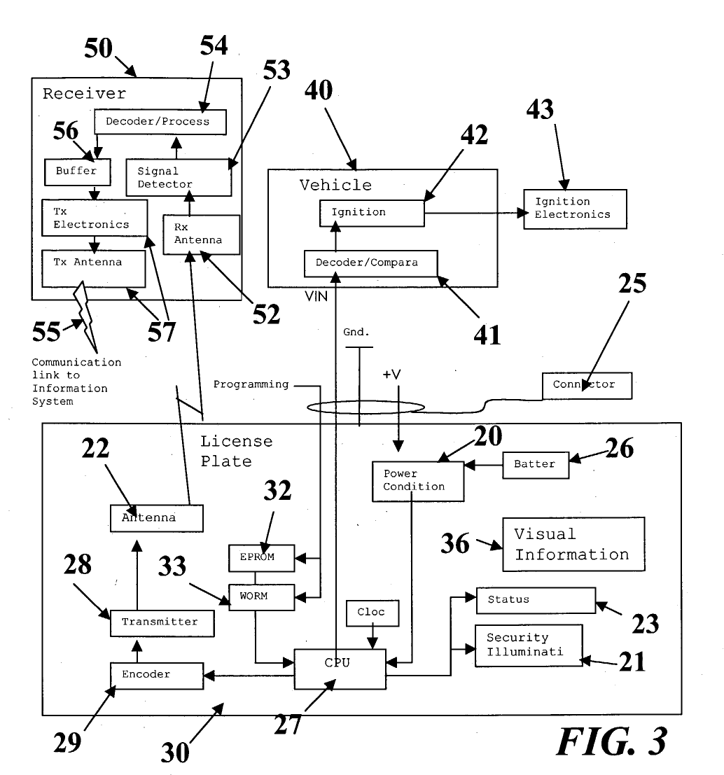

### DESCRIPTION OF A PREFERRED EMBODIMENT

Before explaining a preferred embodiment of the invention in detail, it is to be understood that the invention is not limited to the details of construction and to the arrangements of the components set forth in the following description or illustrated in the drawings. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other systems for carrying out the several purposes of the present invention. It is important, therefore, that the claims be regarded as including such equivalent constructions insofar as they do not depart from the spirit and scope of the present invention.

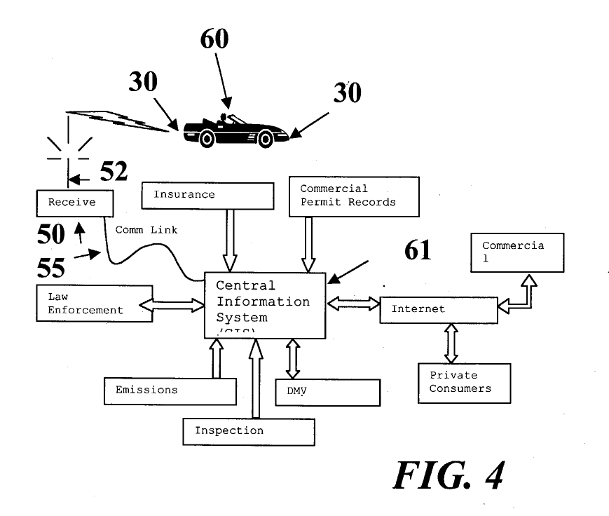

The motor vehicle tracking and information system consists of a tamper-proof, electronic vehicular license plate 30 having all electronic components integrated therein, roadside or mobile receivers 50 for detecting vehicles 60 and decoding the RF transmission, and an information architecture for making the data useful to law enforcement, industry, and private citizens (see FIG. 4).

The license plate 30 is of unitary construction, having all electronics incorporated into the plate. Electronics embedded into the license plate 30 include an antenna 22, at least two one-time programmable (OTP) memory circuits which provide a unique identity to each plate 33, an erasable programmable read-only memory which is used by police officers to write to the plate (EPROM) 32, a CPU 27 and clock circuit, an encoder 29 with a transmitter 28 and antenna 22, status illumination electronics 23, security electronics and illumination 21, power conditioning electronics 20, and a battery 26. All electronics are mounted to a dielectric substrate 31 and encapsulated, or encased between front and rear composite panels 34 and 35 which are permanently joined together either by means of welding or chemical bond.

The write-once read many (WORM) chips are one-time programmable circuits which provide unique identity to the plate 30. One WORM chip is programmed with the license plate number 36 at the time of manufacture. A second WORM chip is reserved for the vehicle ID number and is programmed by the Department of Motor Vehicles when the plate 30 is issued. The EPROM circuit 32 is used by law enforcement for programming the operation of status illumination 23.

The electronic plate 30 is mounted to the vehicle 60 in the typical manner. There is an umbilical 25 between the plate 30 and the vehicle 60 from which the electronics in the plate 30 derive power, and security logic as will be described.

The present invention further includes a radio-frequency electronic vehicle license plate 30, operating in conjunction with vehicular and roadside receivers 50 which detect and decode the signal being transmitted from the license plate 30, and a Central Information System 61 for processing the information. As the vehicle 60 is traveling along the road the electronic plate 30 transmits a code-modulated beam of electromagnetic energy, perpendicular to the plane of the plate, in the direction of travel and generally toward the receiver. Although the plate 30 is always energized, the transmit duty cycle is random, occuring between 0.5-4 seconds. This minimizes the likelihood of the receiver 50 experiencing collisions from several vehicles 60 transmitting at the same time.

The reader 50 will be equipped with different antennas 52 in order to accomplish the desired receive pattern. For example, where traffic is relatively light or moving slowly a single roadside receiver 50 equipped with an omni antenna 52 may be sufficient to read vehicles coming from either direction. Where multiple lanes of traffic are involved multiple readers 50 can be installed at overpasses and equipped with directional antennas 52 to narrow the read pattern to specific lanes. Also, at railroad crossings directional antennas 52 will be used to narrow the receive pattern in order to detect vehicles crossing a specific envelope of track.

Each RF transmission broadcasts the vehicle license number corresponding to the visual number 36 on the plate 30, and vehicle identification number (VIN). Transmission is accomplished at a relatively low power level of about 100 milliwatts. Transmission is asynchronous, or random, but occurs no less than once every four seconds.

The license plate's encoded transmission is detected by the receiver 50, typically out to a distance of 300-500 feet. If traffic is fast moving it may be necessary to install multiple readers 50, separated by several hundred feet in order to ensure detecting all passing vehicles 60.

The receiver is equipped with an antenna 52 and signal detector 53, a decoder/processor 54, a buffer 56 for storage, and transmission electronics 57 including an antenna for data uplink to the CIS 61. The receiver records each vehicle data file and assigns a time/date stamp to each record. At specified times, or when the buffer 56 is approaching capacity, the receiver 50 uplinks stored records to the Central Information System (CIS) 61. The communication link 55 will typically be a microwave link. It is not, however, limited to microwave as there will be applications in which other approaches are preferred.

The CIS 61 is a data bank containing insurance records, DMV records, emissions records, vehicle inspection records, commercial vehicle permit records, and law enforcement records. While law enforcement has full access to these records, others have only limited access through an Internet browser. FIG. 4 illustrates the information architecture.

Several safeguards prevent tampering with the plate 30 to render it inoperative, or switching the plate 30 to another vehicle. At the time of manufacture the plate 30 is programmed with the number corresponding to the license number 36 imprinted on the plate 30. Plates 30 are then shipped to DMV agencies where they are programmed with the VIN number at the time of issue. These numbers are programmed into write-once read-many (WORM) memory devices 33 and cannot be erased or altered. When DMV programs the vehicle identification number (VIN number) into memory 33, a counter circuit is also energized. The purpose of the counter circuit is to detect when the plate 30 has been removed from the vehicle 60, indicating that the plate is being transferred to a non-registered vehicle. Powered by an internal battery 26, this circuit detects when the umbilical 25 to the vehicle 60 has been plugged into the plate 30, and also when the umbilical 25 is unplugged or severed in the event that the plate 30 is removed. In the event that the car battery goes dead the internal battery keeps the plate alive so that the counter does not advance, as doing so would require taking the plate to the DMV and having the counter reset.

If the plate 30 is removed and plugged into another vehicle it continues to transmit it's unique identity, but the code structure is altered which indicates to the Central Information System 61 that the vehicle 60 is operating in non-compliance. As a visual aid to law enforcement, once the counter circuit detects that the plate 30 has been disconnected from the original vehicle 60, the status illumination (typically LED) 21 flashes when plugged into another vehicle 60. If the original vehicle is not equipped with a decoder/comparator circuit, reinstalling the plate 30 on the original vehicle 60 and having it function properly requires that the plate 30 be returned to DMV and the counter reset. If the vehicle is equipped with the comparator circuit 41, the comparator will determine if the VIN number programmed into the plate 30 matches that of the vehicle 60. If it does, then the starter relay 42 is energized, enabling the vehicle start, and the plate automatically resets for proper operation.

The umbilical 25 from the vehicle 60 which energizes the plate 30 is a harness which includes: Vehicle ID Number (VIN) logic, DC voltage, programming, and ground.

The electronic plate 30 is equipped with at least one erasable programmable read only memory (EPROM) 32 for use by law enforcement. Using an external programming device a police officer can program the status illumination 21 to begin flashing after a specified number of days. This gives the vehicle owner a specified number of days to take the vehicle 60 to DMV, resolve the citation and have the plate 30 reset for normal operation. This feature can also be used at border crossings to program vehicles 60 going across country borders for a specified period of time. After the period of time during which the vehicle is to have returned to the originating country, the status illumination 21 will flash. When vehicles return through the port-of-entry the border-guard will cancel the program so that the plate continues to display normal operating status.

Flashing status illumination indicates one of the following conditions:

1. A previous citation has not been resolved within the approved timeframe.

2. The plate 30 has been switched from the vehicle to which it is registered.

3. The vehicle is operating outside compliance of the law for other reasons (e.g., operating outside the country of registration beyond the specified timeframe).

Solid illumination indicates that the electronic plate 30 is functioning properly and that the vehicle is operating in compliance with the law.

The plate 30 is constructed to enable one to visually detect intentional tampering or attempts to disable or impair its performance. Disabling the plate requires that one either cuts through the filler material 34 and 35 and into the dielectric substrate 31 to damage the electronics, or else that one places a reflective tape (e.g. aluminum foil) over the antenna 22 to degrade its performance. In this present embodiment the antenna 22 is printed directly onto the dielectric substrate, which can be either of rigid or flex-circuit construction, and an LED-driven fiber-optic panel 23 is adhered directly to the antenna 22 surface. The LED fiber-optic panel 23 provides illumination to detect if the antenna has been covered or if the electronics have been tampered with. If one tries to cut through to the antenna 22, damage to the fiber-optic display 23 will be apparent by a “hot-spot” where light is localized, with the rest of the display 23 dead. The electronics 24 are located on the back of the plate 30 and they too are protected from intentional tampering by the fiber-optic panel 23. The panel's LED light source 23 is located on the back of the dielectric substrate and the panel is folded over the board to encapsulate the electronic components 24 on the back, and the antenna 22 on the front. If one tries to disable the electronics 24 by cutting into the back of the plate 30, the display 21 on the front of the plate 30 will not illuminate.

Although the preferred tamper-proofing embodiments of this invention have been illustrated and described, it will be apparent to those of ordinary skill that other methods or apparatus can be employed to detect physical tampering. The described embodiment does not preclude the use of other or additional approaches.

In practice, while the vehicle 60 is traveling along the road the electronic plate 30 randomly transmits an encoded beam of low-power electromagnetic energy, corresponding to the visual number 36 on the plate 30, and vehicle identification number (VIN). Unique identity numbers are programmed into write-once read-many (WORM) memory devices 33 and cannot be erased or altered. When DMV programs the VIN number into memory 33, a counter circuit is also energized. This counter circuit detects when the umbilical 25 to the vehicle has been plugged into the plate 30, and also when the umbilical 25 is unplugged or severed in the event that the plate 30 is removed. The umbilical 25 which energizes the plate 30 from the vehicle 60 includes wires for VIN logic, DC voltage, programming, and ground. If the vehicle 60 is equipped with a comparator circuit 41 and starter relay 42, the comparator circuit 41 will determine if the VIN number programmed into the plate 30 matches that of the vehicle 60. If it does not, then the starter relay 42 will not energize and the vehicle 60 will not start.

In addition to the measures described for safeguarding the license plate from tampering or disabling, there will inevitably be a plethora of consumer electronic products designed to jam or confuse the receivers so that vehicles can operate undetected. It is recognized that spread-spectrum or other RF technologies or even other novel approaches may be required to prevent consumer electronics from rendering the system ineffective. It may indeed be necessary to install cameras and a means for vehicle detection in conjunction with readers. Cameras would photograph each vehicle passing that is not read by the receiver. It is understood, therefore, that the preceding embodiment is given merely by way of illustration and not in limitation of the invention and that various modifications may be made thereto without departing from the spirit and scope of the present invention.

What is claimed is:

1. A vehicle tracking system, the system comprising:
a unitary RF electronic license plate attached to a vehicle, the license plate having integrated therein tamper-proof ID and transmitting components, the electronic transmitting components capable of transmitting radio-frequency signals containing information about the license plate and the vehicle;
a series of spaced roadside or mobile receivers for detecting vehicles and decoding the transmission signals into data; and
a Central Information System (CIS) for tracking vehicles, for analyzing violations of law, and for making the data useful to law enforcement, industry, and private citizens.

2. The vehicle tracking system of claim 1 wherein the license plate is constructed with embedded ID electronics which provide a unique electronic signature to the license plate, with security features to detect tampering.

3. The vehicle tracking system of claim 2 wherein the code structure of the unique electronic signature and visible status illumination indicates if the plate has illegally been placed on another vehicle.

4. The vehicle tracking system of claim 2 wherein the electronic components comprise an antenna, an encoder and transmitter, multiple one-time programmable (OTP) memory circuits, an erasable programmable read-only memory (EPROM), a CPU and timing circuit, illumination electronics, security electronics, a battery and power conditioning, all integrated and embedded into the license plate.

5. The vehicle tracking system of claim 4 wherein the electronic transmitting components are mounted to a dielectric substrate in the license plate and encapsulated, or encased in composite materials to prevent tampering.

6. The vehicle tracking system of claim 4 wherein an asynchronous transmission mode, in which the plate randomly transmits the electronic code structure, provides inherent RF collision avoidance with other transponders within range of the receiver.

7. The vehicle tracking system of claim 4 wherein the electronic transmitting components are integrated into a unitary plate having retro-reflective letters and numbers to visually convey the identity of the vehicle, and electronic illumination for tamper-detection and for conveying operational status and other information.

8. The vehicle tracking system of claim 4 wherein a OTP chip is programmed with the license plate number at the time of manufacture and a second OTP chip is reserved for the vehicle ID number and is programmed by the Department of Motor Vehicles when the plate is issued, providing unique identity to the plate.

9. The vehicle tracking system of claim 4 wherein the EPROM is used by law enforcement for programming status illumination electronics on the plate.

10. The vehicle tracking system of claim 2 further comprising an electrical umbilical cord between the plate and the vehicle, from which umbilical cord the electronics in the plate derive power, and through which the plate communicates to the vehicle's on-board computer, if so equipped.

11. The vehicle tracking system of claim 1 wherein the receiver uplinks stored records periodically to a Central Information System (CIS) by means of a communication link comprised of RF and/or landline components.

12. The vehicle tracking system of claim 1 wherein through the Central Information System insurance records, inspection records, DMV records, emissions records, commercial vehicle permit records, law enforcement records and other pertinent data files are utilized and accessible.

13. The vehicle tracking system of claim 12 wherein the Central Information System further comprises a dial-up access means for law enforcement agencies to access the records.

14. The vehicle tracking system of claim 12 wherein the Central Information System further comprises browser-based internet access to tracking information for use by industry and private consumers.

15. The vehicle tracking system of claim 1 wherein the receiver assigns a time/date stamp to each record, enabling the Central Information System to identify all vehicles which were in the proximity of a crime scene at a particular time.

16. The vehicle tracking system of claim 1 wherein the Central Information System checks for compliance with vehicle registration, insurance, inspection, emission requirements and commercial vehicle permits by integrating data from the Department of Motor Vehicles (DMV), law enforcement agencies, insurance companies, emissions testing records and other pertinent data sources.

17. The vehicle tracking system of claim 1 wherein by placing roadside receivers a few miles apart, average vehicle velocity can be determined.

18. The vehicle tracking system of claim 1 wherein receivers are installed at railroad gate crossings and operate in conjunction with signaling means to detect and identify vehicles crossing the tracks when warning lights are flashing, and/or gates are down.

19. The vehicle tracking system of claim 1 wherein receivers operate in conjunction with signaling means at traffic intersections.

20. The vehicle tracking system of claim 1 wherein through the Central Information System citations for moving vehicle violations are automatically processed and issued (e.g., via. Certified mail to the registered vehicle owner).

21. The vehicle tracking system of claim 1 wherein receivers are installed at toll booths for faster vehicle processing and automatic toll invoicing.

22. The vehicle tracking system of claim 1 wherein private enterprise can install readers for local security purposes, such as for limiting vehicular access to secure areas or for monitoring vehicles at fuel pumps in order to identify vehicles which drive off without paying.

23. The vehicle tracking system of claim 14 wherein through the Central Information System individuals and private industry can access information on specific vehicle location for the purpose of scheduling and tracking commercial shipments, tracking rental vehicles, and tracking private vehicles.

24. The vehicle tracking system of claim 1 wherein the Central Information System is used to facilitate traffic studies for community and transportation planning by reporting the specific demographics of vehicular traffic to more accurately assess traffic patterns.

25. The vehicle tracking system of claim 1 wherein the Central Information System is capable of analyzing traffic patterns across country borders for the purpose of identifying vehicles associated with smuggling, drug trafficking, or other illegal activities.

26. The vehicle tracking system of claim 1 including technologies and/or additional subsystems necessary to prevent consumer electronic jamming devices from rendering receivers ineffective.
